(19) United States
(12) Patent Application Publication
(10) Pub. No.: US 2007/0227208 A1
(43) Pub. Date: Oct. 4, 2007

(54) Refrigerator cabinet

(75) Inventor: Fredrik Ostberg, Eskilstuna (SE)

Correspondence Address: PEARNE & GORDON LLP, 1801 EAST 9TH STREET, SUITE 1200, CLEVELAND, OH, 44114-3108, US

(73) Assignee: Dometic Sweden AB, Solna (SE)

(21) Appl. No.: 11/396,876

(22) Filed: Apr. 3, 2006

(51) Int. Cl. B65D 55/14; E05B 65/44; E05B 65/12

(52) U.S. Cl. 70/258; 70/63; 70/81

(57) ABSTRACT

A refrigerator cabinet for use in an engine-driven vehicle, such as a recreational vehicle or a pleasure craft, which vehicle comprises an electrical system, which generates an electrical signal when the engine is running. The refrigerator cabinet comprises a plurality of walls and at least one hinged door for enclosing at least one refrigerator compartment, and a lock for releasable locking of the at least one door in a closed position. The lock comprises a displaceable locking member and an electrically controlled actuator for displacing said locking member between an unlocked position and a locked position, which actuator is electrically connectable to the electrical system of the vehicle, and which actuator is arranged to displace said locking member to said locked position when the engine of the vehicle is running and the electrical system supplies said electrical signal.

### FIELD OF THE INVENTION

The present invention relates to a refrigerator cabinet for use in an engine-driven vehicle, such as a recreational vehicle or a pleasure craft. The invention also relates to a door lock for use in such a refrigerator cabinet.

### BACKGROUND OF THE INVENTION

In modern recreational vehicles such as mobile homes, caravans and pleasure crafts a tendency is to provide the living area of the vehicle with modern household appliances. It is has shown desirable that these modern appliances differ as little as possible from corresponding appliances normally used in permanent homes. For example refrigerators used in modern recreational vehicles are very similar to household refrigerators what concerns the dimensions, number and type of compartments and capacity. A modern refrigerator for a recreational vehicle may thus comprises at least one refrigerator compartment and at least one freezer compartment and may have outer dimensions up to 65×32×24 inches (H×W×D).

A general problem when using such refrigerators in recreational vehicles is that the doors of the refrigerator may be unintentionally opened during movement of the vehicle. When the vehicle is travelling it may incline or sway, whereby forces are applied to the doors of the refrigerator, which forces may cause the doors to open. Such unintentional opening of the refrigerator doors is naturally most unwanted since goods stored in the refrigerator compartments may fall out and since the temperature in the compartments will be adversely affected if the doors are left opened for a longer period of time. Such unintentional opening of the doors during travelling may also lead to damaging of the doors or even to the doors being detached from the refrigerator cabinet.

Modern refrigerators for use in recreational vehicles, just as household refrigerators, normally comprise a magnetic seal for keeping the doors sealingly closed. However, the magnetic forces of these seals are not strong enough to keep the door closed when forces in the opening direction are applied to the door during travelling. For remedy of this problem several different types of mechanical hooks and ratchets have been developed.

The hooks or ratchets may be constructed so that they need to be manually engaged before travelling and manually disengaged at arrival, for allowing opening of the refrigerator. Such need for manual operation is however cumbersome. Especially the need for manual locking causes problems since it may easily be forgotten before departure, whereby the refrigerator may be unintentionally opened during travel.

Prior art refrigerators also comprise hooks or ratchets constructed so that the doors may be closed in a normal manner without manipulating the hook or ratchet. When the door is to be opened however, it is necessary to manually unlock the hook or ratchet before the door is opened. Opening of the refrigerator door thus normally requires the use of both hands. These prior art arrangements have shown to be experienced as complicated, awkward and irritating to many users. The same problems also apply when using refrigerator cabinets in other vehicles such as in pleasure crafts or powered yachts.

### SUMMARY OF THE INVENTION

It is therefore an object of the present invention to provide an improved refrigerator cabinet for recreational vehicles, at which refrigerator cabinet the door or doors may be securely retained in the closed position when the vehicle is travelling.

It is a further object to provide such a refrigerator cabinet, which is easy to use.

It is a still further object to provide such a refrigerator cabinet, which may be opened by simply pulling a door handle of a refrigerator door when the vehicle is standing still.

Another object is to provide such a refrigerator cabinet which automatically locks the doors in a closed position when the engine of the vehicle is running and which unlocks the doors when the engine is stopped.

According to the invention, these and other objects are achieved by a refrigerator cabinet for use in an engine-driven vehicle, such as a recreational vehicle or a pleasure craft, which vehicle comprises an electrical system, which generates an electrical signal when the engine is running. The refrigerator cabinet comprises a plurality of walls and at least one hinged door for enclosing at least one refrigerator compartment, and a lock for releasable locking of the at least one door in a closed position. The lock comprises a displaceable locking member and an electrically controlled actuator for displacing said locking member between an unlocked position and a locked position, which actuator is electrically connectable to the electrical system of the vehicle, and which actuator is arranged to displace said locking member to said locked position when the engine of the vehicle is running and the electrical system supplies said electrical signal.

By this means, the door or doors of the refrigerator is automatically locked in the closed position as soon as the vehicle engine is started. It is thus accomplished that the doors are held in the closed position during movement or travel of the vehicle. The risk of unintentional opening of the doors caused by e.g. inclining or swaying of the vehicle during travel is thereby reduced or eliminated. Such a secure holding of the doors in the locked position is, according to the invention, accomplished fully automatic without any need for manual operation of the refrigerator or its lock.

The electrical signal used for controlling the actuator of the lock may be a so called D+-signal, which is outputted from generators commonly used in normal electrical systems of vehicles, when the engine is running and the generator is active. However, the invention also anticipates that the signal, which is supplied by the electrical system of the vehicle, may be generated by other means. For instance the signal may be outputted from a relay, which is activated e.g. by the speedometer of the vehicle. The actuator may also be connected to the ignition lock of the vehicle, whereby turning on the ignition lock activates the actuator. The actuator may also be activated by a separate switch, which is connected to the electrical system of the vehicle and manually activated.

The actuator is preferably arranged to displace the locking member to the unlocked position when the electrical system stops supplying said electrical signal. By this means also unlocking of the refrigerator doors is accomplished fully automatically, whereby no manual operation of the refrigerator lock is needed during normal use.

The actuator is preferably arranged to be power supplied for displacing said locking member by said electrical signal. Thereby no additional power supply for driving the locking member is needed. Hence the control and driving of the locking member may be completely independent of any electrical system of the refrigerator cabinet. Especially, the functioning of the lock is independent of whether or not the main switch of the refrigerator is turned on or off.

The actuator may also alternatively, or in combination with being power supplied by the electrical signal of the vehicle, be power supplied by an electrical system comprised in the refrigerator cabinet. The power supplied by he electrical system of the refrigerator may for instance be used for automatic unlocking of the lock when the engine of the vehicle is turned off and the electrical system of the vehicle stops supplying the signal.

The locking member is preferably displaceable arranged in a lock housing which is fixed to a frame of the refrigerator cabinet. A lock pin may be attached to at least one of said doors and arranged to be received in said housing and to therein engage said displaceable locking member when said door is in its closed position and said locking member is in its locked position. This allows e.g. that one single lock housing may be used for simultaneous locking and unlocking of several doors of the cabinet.

The lock pin is preferably restrictedly, axially displaceable between a retracted and a protruding position relative to said door and biased by a spring towards the protruding position. This allows the lock pin to engage said locking member when the locking member is in the locked position during movement of the door from an open to the closed position. The locking member may comprise a tapered surface arranged to, in contact with a protruding end of said lock pin, urge the lock pin towards the retracted position when the door is moved from an open to the closed position and the locking member is in the locked position. By this means the door may be easily closed without the need for any manual operation of the lock also when the lock is in its locked position.

The locking member preferably comprises a grip for allowing manual displacement of the locking member between the locked and the unlocked position. This allows e.g. for manual override of the lock in case of malfunctioning. The grip may also be used for intentional manual unlocking of the lock during travel of the vehicle.

The actuator may comprise a geared DC motor and the displaceable locking member a gear rack cooperating with the geared DC motor. By this means a simple, space saving and reliable construction is achieved.

The lock preferably comprises an electronic circuit for controlling the movement of the locking member and a sensor, such as an optical sensor, arranged to detect the position of the locking member. By this means a number of additional functions of the lock, as described below in the detailed description, may be accomplished.

The refrigerator may comprise any suitable number of compartments and doors. For instance it may comprise two compartments arranged one above the other and separated by a horizontal partition wall, each compartment being enclosable by a door which is hinged at a side edge of the cabinet, wherein the lock is fixed to the horizontal partition wall and each door is provided with a respective lock pin, which is arranged to be engaged by the displaceable locking member of the lock when the locking member is in the locked position and the respective door is in the closed position.

Preferably, the refrigerator comprises two compartments arranged one above the other and separated by a horizontal partition wall, each compartment being enclosable by a pair of doors which are hinged at opposite side edges of the cabinet.

Alternatively, the refrigerator cabinet may comprise three compartments arranged one centrally below two and separated from each other by a partition wall which has the general shape of an inverted T, the lower compartment being enclosable by a pair of doors hinged at opposite side edges of the cabinet and the upper compartments being enclosable by respective doors hinged at opposite side edges of the cabinet.

The refrigerator cabinet may also comprise two compartments arranged one above the other and separated from each other by a horizontal partition wall, each compartment being enclosable by a door which is hinged at a side edge of the cabinet

The refrigerator cabinet may also comprise four compartments arranged in pairs, one pair above the other and separated from each other by a cross-shaped partition wall, each compartment being enclosable by a door which is hinged at a side edge of the cabinet.

The refrigerator may also comprise two compartments arranged side by side and separated from each other by a vertical partition wall, each compartment being enclosable by a door which is hinged at a respective side edge of the cabinet.

The invention also concerns to a lock for a refrigerator cabinet for use in an engine-driven vehicle, such as a recreational vehicle or a pleasure craft, which vehicle comprises an electrical system which generates an electrical signal when the engine is running, and which refrigerator cabinet comprises a plurality of walls and at least one hinged door for enclosing at least one refrigerator compartment; the lock comprising a lock pin fixable to the at least one door, a lock housing which is fixable to a frame of the refrigerator cabinet and which accommodates a displaceable locking member and an electrically controlled actuator for displacing said locking member between an unlocked position and a locked position, which actuator is electrically connectable to the electrical system of the vehicle, and which actuator is arranged to displace said locking member to said locked position when said electrical system supplies said electrical signal.

### BRIEF DESCRIPTION OF THE DRAWINGS

In the following exemplifying embodiments of the invention will be described with reference to the accompanying drawings in which:

FIG. 1 is a schematic side view of a recreational vehicle with a refrigerator cabinet according to the invention.

FIG. 2 is a schematic front view of an embodiment of the refrigerator cabinet of the invention.

FIG. 3 is an exploded perspective front view the of a stationary lock part comprised in the refrigerator cabinet shown in FIG. 2.

FIG. 4 is a perspective rear view of the lock part shown in FIG. 3, where certain members have been removed.

FIGS. 5a and 5b are front views of the lock part shown in FIG. 3 showing the lock part in two different states.

FIG. 6a is a sectional view in enlarged scale along line A-A in FIG. 2 showing the lock in a first state.

FIG. 6b is a front view in enlarged scale with some parts removed of a portion of the refrigerator cabinet shown in FIG. 2, showing the lock in the first position shown in FIG. 6a.

FIGS. 7a and 7b are views corresponding to those of FIGS. 6a and 6b, showing the lock in a second position.

FIGS. 8a is a sectional view in enlarged scale along line B-B of FIG. 2 with some parts removed and illustrating the movement of a lock member during closing of a refrigerator door.

FIG. 8b is a perspective view from the front of the lock members shown illustrated in FIG. 8a.

### DETAILED DESCRIPTION OF EMBODIMENTS

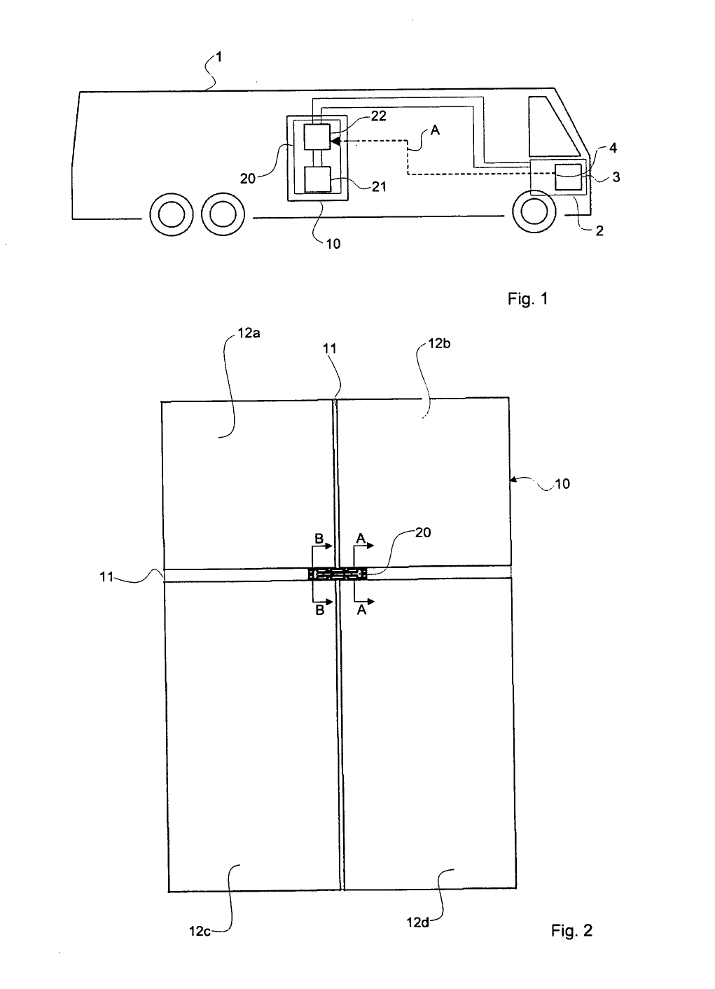

In FIG. 1 a recreational vehicle 1 in the form of a mobile home is shown schematically. The vehicle 1 comprises an electrical system 2, which is connected to the engine (not shown) of the vehicle. The electrical system comprises a DC generator 3, which, as is normal for generators at recreational vehicles, generates a DC-signal A of approx. +14 V when the engine is running. This signal A is normally referred to as a D+ signal and is generated by the generator only when the engine is running and the generator is generating a DC power supply voltage to the electrical system 2. The power supply voltage generated by the generator is as usual used for power supply of the electrical system and for charging the battery of the vehicle. The D+ signal A is outputted on a terminal 4 on the generator only when the engine is running. When the engine is not running no signal is outputted on the terminal 4, even if the ignition switch or ignition lock of the vehicle is turned on.

A refrigerator cabinet 10 according to the invention is placed in a living area of the recreational vehicle 1. The refrigerator cabinet 10 comprises a lock 20 for preventing the doors of the refrigerator from being unintentionally opened during travel, when the engine of the vehicle 1 is running. The lock comprises an electrical actuator in the form of a DC motor 21 and an electrical circuit board 22 with electrical components for controlling the movement of the DC motor.

The electrical circuit board 22 is connected to and supplied with power from an electrical system of the refrigerator 10. The electrical system of the refrigerator is connected to and supplied by the electrical system 2 of the vehicle. The electrical system of the refrigerator also comprises a refrigerator main switch (not shown) for connecting and disconnecting the power supply from the electrical system 2 of the vehicle to the refrigerator. The DC motor is further connected to and supplied by the circuit board 22.

FIG. 2 is a front elevation view of a refrigerator cabinet 10 according to the invention. The cabinet comprises exterior top, bottom, rear and side walls (not shown). The cabinet further comprises a generally cross-shaped interior partition wall 11, dividing the interior of the cabinet into four compartments. The exterior and interior walls of the refrigerator are hereinafter referred to as a frame of the refrigerator cabinet. Each compartment is enclosed by a respective front door 12a-12d. The doors are arranged in pairs, one pair 12a, 12b being arranged above the other 12c, 12d. In each pair the doors are hingedly fixed to opposite side edges of the cabinet such that the upper 12a and lower 12c left side doors are left-handed and the upper 12b and lower 12d right doors are right-handed. The lock 20 is fixed to the front surface of the partition wall 11, centrally and symmetrically in relation those corners of the doors that are proximate to each other when the doors are closed.

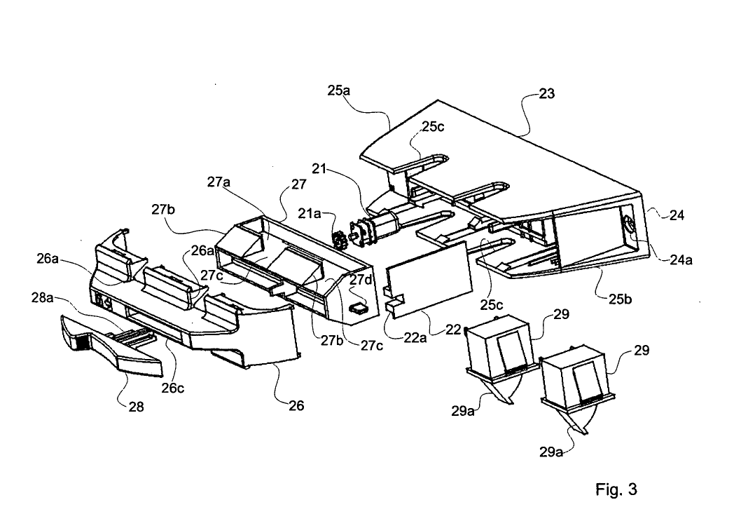

FIG. 3 is an exploded view of the stationary part of the lock, which stationary part, when mounted, is fixed to the generally cross-shaped partition wall 11 of the cabinet frame. The stationary part comprises a housing, which comprises a base member 23 and a front member 26.

The base member 23 comprises a base plate 24, an upper 25a and a lower 25b sidewall, which sidewalls 25a, 25b extend perpendicularly from the base plate and in parallel with each other. Two slots 25c are arranged in each of the upper and lower sidewalls. The slots 25c extend from the free edge of the respective sidewall 25a, 25b in a direction towards the base plate 24. Two through holes 24a are arranged in the base plate 24 for fixing the housing to the refrigerator cabinet by means of threaded screws (not shown).

The front member 26 is fixedly snap-fitted to the base member 23. The front member 26 is generally closing the base member 23. However, two upper and two lower (see e.g. FIG. 5a) slots 26a are arranged in the front member, in alignment with one each of the slots 25a of the base member. The front member 26 also comprises an elongated central through opening 26c.

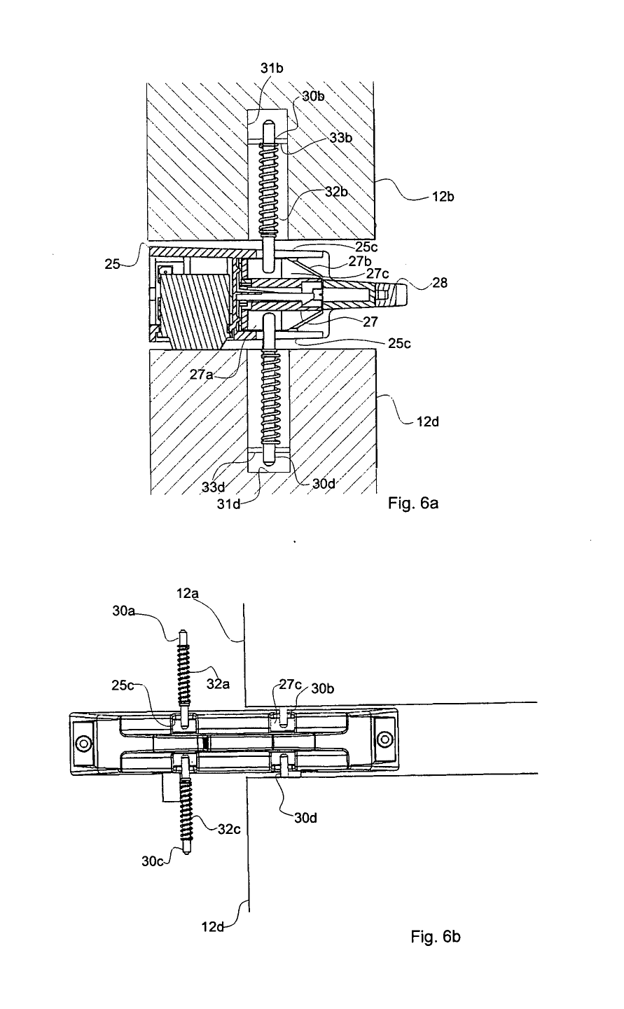

An elongated locking member 27 is received in the housing and arranged to be longitudinally displaced back and forth in parallel with the base plate 24 and the sidewalls 25. The locking member is provided with an upper and a lower recess 27a. Each of the upper and lower recesses 27a is partially closed forwardly by two engagement stops 27b. Each engagement stop 27b has a vertical rear side and a front side, which is forwardly tapering towards a horizontal central plane of the stationary part of the lock. Each of the upper 27a and lower recesses also has two forwardly open passages 27c for allowing the protruding end of a lock pin 30 (see e.g. FIG. 6) attached to a door to be swung into and out from the recess 27a. The locking member 27 further comprises a protruding tab 27d arranged at one end of the elongated locking member.

The geared DC motor 21 has a gear wheel 21a arranged on its output shaft and is fixed in the base member 23. Also the circuit board 22 is fixed in the base member. A U-shaped optical sensor 22a is fixed to the circuit board and arranged to detect that the tab 27d of the locking member 27 is received between its legs.

A grip 28 is arranged in front of the front member 26. The grip 28 comprises a snap hook 28a, which extends through the elongated opening 26c of the front member 26 and is snap-fitted to the locking member 27. By this means the grip 28 is fixed to the locking member 27 and displaceable together with this in relation to the base 23 and front 26 members of the lock housing.

Two switches 29 are arranged in the base member 23 such that a movable part 29a of each switch protrudes from respective openings (not shown) in the lower sidewall 25b of the base member.

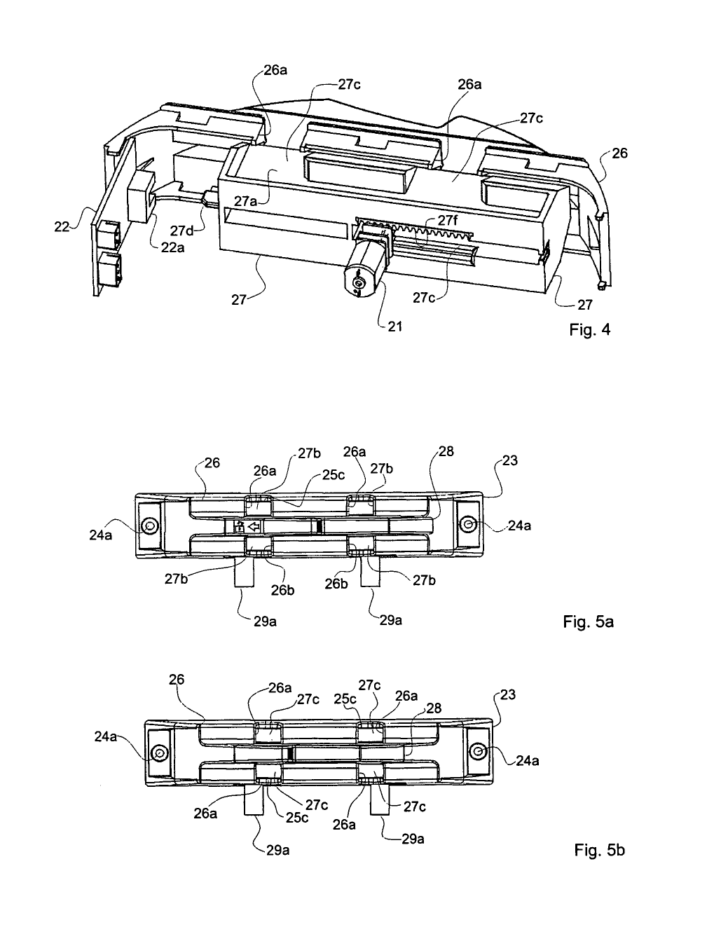

FIG. 4 is a perspective view from behind of the assembled stationary part of the lock. For reasons of easier understanding, the base member 23 and the switches 29 are removed in FIG. 4. As is best seen in FIG. 4 a longitudinally extending recess 27e is arranged in the rear side of the elongated locking member 27. The upper sidewall of the recess 27 is provided with a gear rack 27f. The gear wheel 21a of the motor 21 engages the gear rack 27f, for displacing the locking member 27 in either longitudinal direction upon rotation of the motor in a corresponding rotational direction.

In FIGS. 4 and 5b the locking member 27 is in its unlocked position. In this position the passages 27c of the locking member are aligned with the corresponding slots 26a of the front member 26 and with the corresponding slots 25c of the base member to thereby form a free forward passage into the upper and lower recess 27a of the locking member 27.

In FIG. 5a the locking member 27 is in its locked position. In this position the locking member 27 and the grip 28 has been displaced to the right in relation to the unlocked position shown in FIG. 5b. In the locked position the engagement stops 27b of the locking member are aligned with the corresponding slots 26a, 25c of the front member 26 and the base member 25. Thereby the forward passage into and out of the upper and lower recesses 27a of the locking member 27 is blocked.

FIGS. 6a and 6b shows the lock in the unlocked position. From these figures it can be seen that a lock pin 30a-c is arranged in each door 12a-d. Each lock pin 12a-d is received in a vertically oriented cylindrical recess 31b, 31d which is arranged in the corresponding door 12a-d. The cylindrical recesses 31b of the upper doors 12a, 12b extend into the respective door from its lower edge and the recesses 31d of the lower doors 12c, 12d extend into the respective door from its upper edge. The recess of the upper left side door 12 is aligned with the recess of the lower left side door 12c and the recess 31b of the upper right side door is aligned with the recess 31d of the lower right side door 12d. A compression spring 32a-d is arranged around each lock pin 30a-d. Each compression spring 32a-b is attached to its lock pin 30a-d at the end of the spring being arranged proximal to the opening of the recess. The other end of each spring bears against a stop 33b, which is arranged in the recess and is fixed in relation to the door. When the spring 32a-d is unloaded, the corresponding lock pin is in a protruding position (shown in FIG. 6a) In the protruding position, the free end of the lock pin 30a-d protrudes out from the respective cylindrical recess 32a-d to such an extent that the free end may extend through the respective slot 25c in the base member 25 and be received in the upper or lower recess 27a of the locking member 27. From this unloaded, protruding position each lock pin 30a-d may be urged to a retracted position, in which the free end of the lock pin may pass the corresponding engagement stop 27b of the locking member.

In the unlocked position shown in FIGS. 6a and 6b the locking member 27 is in its unlocked position, whereby the forward passages out of the upper and lower recess 27a of the locking member are free. The lock pins 30a-d may thereby freely move out (to the right in FIG. 6a) from the upper and lower recesses 27a of the locking member 27, when the doors 12a-d are swung open.

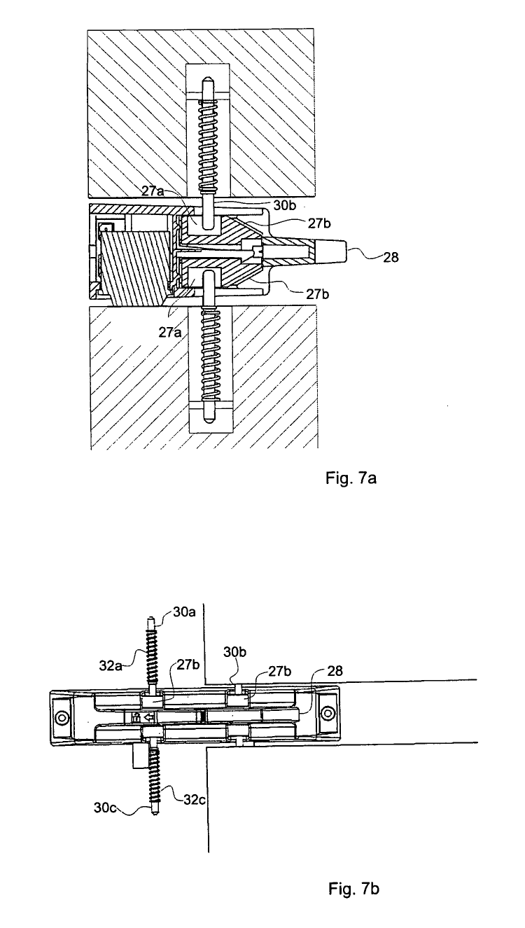

In FIGS. 7a and 7b the locking member 27 is in the locked position. I this position the engagement stops 27b block the forward passages out from the upper and lower recess 27a of the locking member 27. If an opening force is applied to any of the doors 12a-d, the free end of the respective lock pin 30a-d will contact and engage the rear vertical wall of the respective engagement stop 27b, whereby opening of the door is prevented.

As indicated in FIGS. 6a, 6b, 7a and 7b the movable parts 29a of the switches 29 are contacted and pushed by the upper edges of the lower doors 12b, 12d when these doors are closed. The switches 29 are connected to respective interior lamps in the lower compartments and used for controlling these lamps such that they are lit when the when the respective door is opened and switched off when it is closed.

For control of the lock, the circuit board 22 comprises programmable electronic components for controlling the rotation of the DC motor 21 as follows. When the refrigerator main switch is turned on, the circuit board 22 and the motor 21 are supplied by the electrical system of the refrigerator. When the engine of the vehicle is started, the D+ signal A is high, i.e. approx. +14 V, whereby the circuit board outputs approx. +4 V to the electrical motor, in order to rotate the motor in a first rotational direction. The locking member 27 is thereby displaced to its locked position. The electrical current supplied to the motor is measured by a current meter on the circuit board and the voltage supplied to the motor is cut off when the motor current reaches a threshold indicating that the locking member has reached its end position. When the vehicle engine is turned off the D+ signal goes low (approx. 0 V), whereby the circuit board outputs approx. −4 V to the motor 21 in order to rotate the motor in the opposite direction to thereby displace the locking member to its unlocked position. Also in this case the current meter measures the current fed to the motor and the voltage supplied to the motor is cut off when the current reaches a threshold indicating that the locking member has reached its other end position.

For avoiding that the locking member is repeatedly displaced back and forth if D+ is rapidly shifting between high and low during an attempt to start the vehicle engine, the motor is not supplied with a voltage until the D+ has reach a steady state. The time delay for deciding when the D+ signal has reach a steady state may be changed by altering the control program. The time delay may suitable be set to approx. 2 seconds.

When the locking member 27 is in the locked position, the tab 27b is received between the legs of the optical sensor 22a, whereby the locking position is indicated to the control program. If the locking member does not reach its locked position when it should, e.g. because a door is not correctly closed, a new attempt to displace the locked position is made after a certain time delay. Before the new attempt to displace the locking member to the locked position is made, the locking member is first displaced to the unlocked position. The time delay after which the new attempt is made may be set in the program and is suitably set to approx. 5 seconds. Also the number of new attempts to be made may be set in the program and is suitably set to two.

If the main switch of the refrigerator is turned off when the vehicle engine is started and the D+ signal goes high, the D+ signal itself is outputted to supply the motor. Thereby the locking member is moved to the locked position when the engine is started, even if the refrigerator main switch is turned off or if the electrical system of the refrigerator for any other reason is not supplied with a supply voltage. In this case, the locking member will not be automatically displaced to the unlocked position when the engine is turned off and the D+-signal goes low. Instead the locking member may be manually displaced to the unlocked position by griping the grip 28 and moving the grip and locking member to the unlocked position.

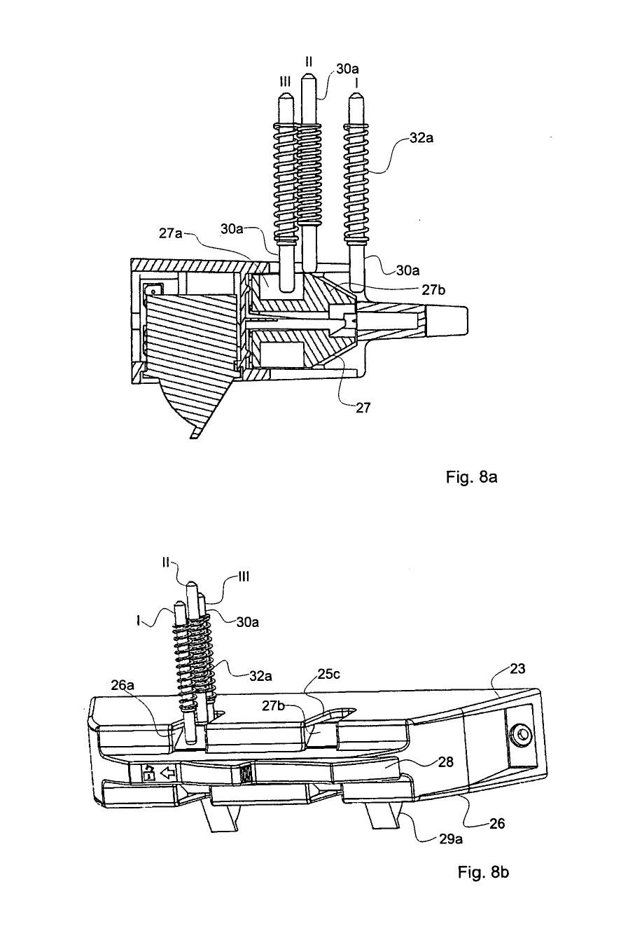

When the locking member is in its locked position the lock may always be manually unlocked by griping the grip and moving the locking member to the unlocked position. If the D+-signal is high during such a manual unlocking the lock will automatically be locked after a time delay, suitable approx. 5 seconds, set in the program. Thus, even if the vehicle engine is running it is possible to manually unlock the lock in order to be able to open the doors. If the door is then kept open for more than 5 seconds the locking member will return to its locked position. As schematically indicated in FIGS. 8a and 8b it is then still possible to close the door even though the locking member is in its closed position. During such closing of the door, the lock pin 30b will move from position I, through position II to position III as indicated in FIGS. 8a and 8b. During closing of the door, the free end of the lock pin 30b will contact the forward tapering surface of the engagement stop 27b. The lock pin will then in contact with the tapering surface be urged against the action of the spring 32b to its retracted position (cf. position II). Thereafter, the lock pin will pass the engagement stop and be forced by the action of the spring to regain its protruding position (cf. position III), in which the free end of the lock pin is received in the upper recess 27a of the locking member 27. The door is then again locked by the engaging cooperation of the rear vertical wall of the engaging stop 27b and the free end of the lock pin 30b. The same applies to all doors and lock pins.

Above an exemplifying embodiment of the invention has been described. Naturally the invention is not limited to this embodiment but it may be freely varied within the scope of the appended claims. For instance the exemplifying refrigerator cabinet comprises four doors enclosing four compartments. It is however understood that the refrigerator may alternatively comprise e.g. one, two or three doors enclosing e.g. one, two three or four compartments, whereby the number of lock pins and the geometry of the stationary part of the lock is adapted accordingly. The actuator may comprise a motor having a threaded shaft in which case the locking member may comprise a threaded nut or the like cooperating with the threaded shaft for displacing the locking member. The actuator may also comprise a solenoid or any other electromechanical component arranged for displacing the locking member. The sensor for detecting the position of the locking member may instead of being formed of an optical sensor comprise a mechanical switch. It may also comprise a Hall-element or a Reed contact in which cases the locking member would comprise a magnet for being detected by the sensor.

1. A refrigerator cabinet for use in an engine-driven vehicle, such as a recreational vehicle or a pleasure craft, which vehicle comprises an electrical system which generates an electrical signal when the engine is running, said refrigerator cabinet comprising a plurality of walls and at least one hinged door for enclosing at least one refrigerator compartment, and a lock for releasable locking of the at least one door in a closed position, wherein said lock comprises a displaceable locking member and an electrically controlled actuator for displacing said locking member between an unlocked position and a locked position, which actuator is electrically connectable to the electrical system of the vehicle, and which actuator is arranged to displace said locking member to said locked position when said electrical system supplies said electrical signal.

2. The refrigerator cabinet according to claim 1, wherein the actuator is arranged to displace the locking member to said unlocked position when said electrical system stops supplying said electrical signal.

3. The refrigerator cabinet according to claim 1, wherein said actuator is arranged to be power supplied for displacing said locking member by said electrical signal.

4. The refrigerator cabinet according to claim 1, wherein said actuator is power supplied for displacing said locking member by an electrical system comprised in the refrigerator cabinet.

5. The refrigerator cabinet according to claim 1, wherein said locking member is displaceable arranged in a lock housing which is fixed to a frame of the refrigerator cabinet and wherein a lock pin is attached to at least one of said doors and arranged to be received in said housing and to therein engage said displaceable locking member when said door is in its closed position and said locking member is in its locked position.

6. The refrigerator cabinet according to claim 5, wherein said at least one lock pin is restrictedly, axially displaceable between a retracted and a protruding position relative to said door and biased by a spring towards the protruding position for allowing said lock pin to engage said locking member when the locking member is in the locked position during movement of the door from an open to the closed position.

7. The refrigerator cabinet according to claim 6, wherein said locking member comprises a tapered surface arranged to, in contact with a protruding end of said lock pin, urge the lock pin towards the retracted position when the door is moved from an open to the closed position and the locking member is in the locked position.

8. The refrigerator cabinet according to claim 1, wherein said locking member comprises a grip for allowing manual displacement of the locking member from the locked to the unlocked position

9. The refrigerator cabinet according to claim 1, wherein the actuator comprises a geared DC motor and the displaceable locking member comprises a gear rack cooperating with the geared DC motor.

10. The refrigerator cabinet according to claim 1, wherein the lock comprises an electronic circuit for controlling the movement of the locking member and a sensor arranged to detect the position of the locking member.

11. The refrigerator cabinet according to claim 10, wherein the sensor is an optical sensor arranged to detect when the locking member is in its locked position.

12. The refrigerator cabinet according to claim 1, comprising four compartments arranged in pairs, one pair above the other and separated from each other by a cross-shaped partition wall, each compartment being enclosable by a door which is hinged at a side edge of the cabinet, wherein the lock is fixed to a central portion of the cross-shaped partition wall and each door is provided with a respective lock pin, which is arranged to be engaged by the displaceable locking member of the lock when the locking member is in the locked position and the respective door is in the closed position.

13. The refrigerator cabinet according to claim 1, comprising two compartments arranged one above the other and separated by a horizontal partition wall, each compartment being enclosable by a door which is hinged at a side edge of the cabinet, wherein the lock is fixed to the horizontal partition wall and each door is provided with a respective lock pin, which is arranged to be engaged by the displaceable locking member of the lock when the locking member is in the locked position and the respective door is in the closed position.

14. The refrigerator cabinet according to claim 1, comprising two compartments arranged one above the other and separated by a horizontal partition wall, each compartment being enclosable by a pair of doors which are hinged at opposite side edges of the cabinet, wherein the lock is fixed to the horizontal partition wall and each door is provided with a respective lock pin, which is arranged to be engaged by the displaceable locking member of the lock when the locking member is in the locked position and the respective door is in the closed position.

15. The refrigerator cabinet according to claim 1, comprising three compartments arranged one centrally below two and separated from each by a partition wall having the general shape of an inverted T, the lower compartment being enclosable by a pair of doors hinged at opposite side edges of the cabinet and the upper compartments being enclosable by respective doors hinged at opposite side edges of the cabinet, wherein the lock is fixed to a central portion of the partition wall and each door is provided with a respective lock pin, which is arranged to be engaged by the displaceable locking member of the lock when the locking member is in the locked position and the respective door is in the closed position.

16. The refrigerator cabinet according to claim 1, comprising two compartments arranged one above the other and separated from each other by a horizontal partition wall, each compartment being enclosable by a door which is hinged at a side edge of the cabinet, wherein the lock is fixed to a central portion of the horizontal partition wall and each door is provided with a respective lock pin, which is arranged to be engaged by the displaceable locking member of the lock when the locking member is in the locked position and the respective door is in the closed position.

17. The refrigerator according to claim 1, comprising two compartments arranged side by side and separated from each other by a vertical partition wall, each compartment being enclosable by a door which is hinged at a respective side edge of the cabinet, wherein the lock is fixed to a central portion of the vertical partition wall and each door is provided with a respective lock pin, which is arranged to be engaged by the displaceable locking member of the lock when the locking member is in the locked position and the respective door is in the closed position.

18. A lock for a refrigerator cabinet for use in an engine-driven vehicle, such as a recreational vehicle or a pleasure craft, which vehicle comprises an electrical system which generates an electrical signal when the engine is running, and which refrigerator cabinet comprises a plurality of walls and at least one hinged door for enclosing at least one refrigerator compartment; the lock comprising a lock pin fixable to the at least one door, a lock housing which is fixable to a frame of the refrigerator cabinet and which accommodates a displaceable locking member and an electrically controlled actuator for displacing said locking member between an unlocked position and a locked position, which actuator is electrically connectable to the electrical system of the vehicle, and which actuator is arranged to displace said locking member to said locked position when said electrical system supplies said electrical signal.
